(19) United States
(12) Patent Application Publication
(10) Pub. No.: US 2019/0099677 A1
(43) Pub. Date: Apr. 4, 2019

(54) System and Method for a Multiplayer Mobile Device-based Virtual Assassin Game

(71) Applicants: Kevin T. Squires, Monroe, NJ (US); Eveline H. Brownstein, Rumson, NJ (US)

(72) Inventors: Kevin T. Squires, Monroe, NJ (US); Eveline H. Brownstein, Rumson, NJ (US)

(21) Appl. No.: 15/721,920

(22) Filed: Oct. 1, 2017

(51) Int. Cl. A63F 13/837; A63F 13/332; A63F 13/69; A63F 13/75; H04M 1/725

(52) U.S. Cl. CPC A63F 13/837; A63F 13/332; H04M 1/72544; A63F 13/75; A63F 13/69

(57) ABSTRACT

The present invention relates to a game operated through an application, installed on a mobile device, with the core rule set being managed on a centralized, computer server. The purpose of the game is for player Assassins to eliminate player Targets. The server contains algorithms which uses information provided by the mobile device, including, but not limited to, geo-location, device orientation, and user-selected virtual weapons and defense tools, to determine whether Assassins have successfully eliminated their Targets. Virtual weapons and defense tools may be acquired by players through credits earned, based on game scoring, or when purchased.

### FIELD OF THE INVENTION

The present invention relates to a server-based system and method of interactive game play wherein multiple players possessing mobile devices, can engage in play with one another.

### BACKGROUND OF THE INVENTION

A mobile game is a video game played on a feature phone, smartphone, smartwatch, PDA, tablet computer, or portable media player. The earliest known game on a mobile phone was a Tetris variant on the Hagenuk MT-2000 device from 1994. In the years since then, the use of mobile devices to play games has become very popular. As a result, there are now many game software applications which can be used on a mobile device. Currently available games are designed for the player to compete with the computer software downloaded on the device itself, or with another player using a similar device, at a distance, with little to no location relevancy for the players. The game described herein, allows for the players to use the popular technology of location-enabled mobile devices in a multiplayer game, to facilitate the players' ability to interact face-to-face and within a specified location range, which other mobile device-based games typically do not allow for.

### SUMMARY OF THE INVENTION

The present invention relates to a system and method of interactive game play wherein multiple players possessing mobile devices, with their device's existing location services enabled as provided by the mobile device's manufacturer, can track one another. Once within an established radius, which is based on the device's existing location and GPS services, a player, utilizing virtual tools provided by the server-based, game software can eliminate from the game another player which the server-based software application has identified as a target; or, the target player can escape utilizing virtual tools provided by the server-based, game software.

### BRIEF DESCRIPTION OF THE DRAWINGS

FIG. 1. Block diagram of the system architecture of one embodiment of the present invention.

FIG. 2. Diagram of the one embodiment of the present invention showing the game in play.

### DETAILED DESCRIPTION OF THE INVENTION

The detailed description set forth below, relating to the appended drawings is intended as a description of the presently preferred embodiments of the invention and is not intended to represent the only forms in which the present invention may be constructed and/or utilized.

1. System Overview:

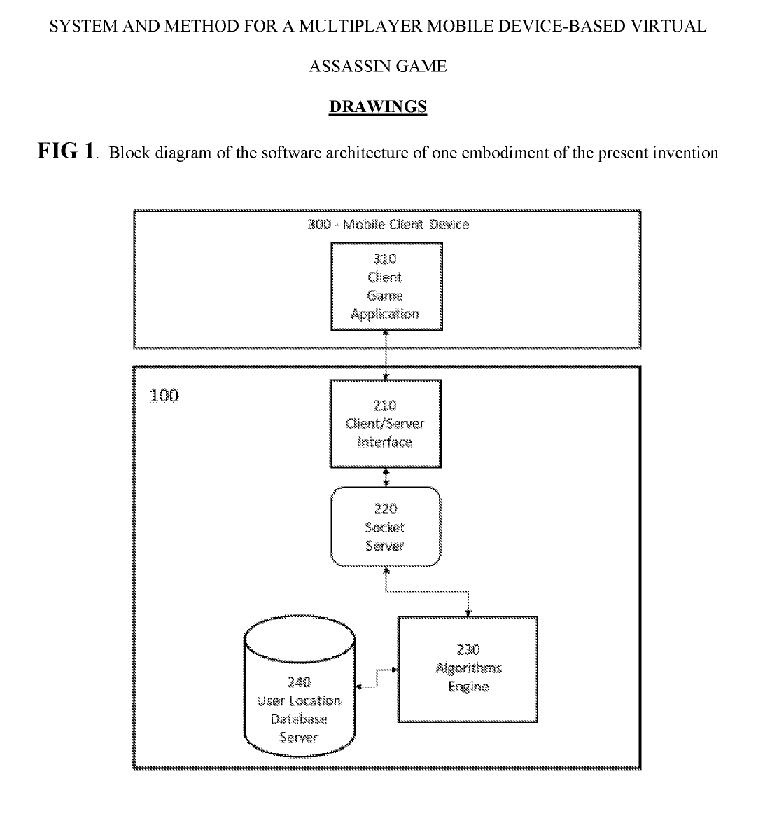

Referring to FIG. 1, showing the system architecture of an embodiment of a gaming system (100), in accordance with one embodiment of the present invention. In this embodiment, the system includes a client/server interface (210), a user location database server (220), and an algorithms engine (230). A client/server interface (210) connects a mobile client device (300) with the gaming system (100). A client game application (310) will be installed on the mobile client device (300).

The Client Game Application (310) will be downloaded by the mobile client device user to the Mobile Client Device (300), using a pre-existing software application that was supplied with and licensed to the Mobile Client Device (300). The mobile client device user will use the downloaded and installed client game application (310) to register as a user of the gaming system (100), establish a new game, and/or connect to an existing game.

The client interface (210) will receive location data and other client requests from the mobile client devices (300). This data will be fed through the socket server (220) to the algorithms engine (230) and User Location Database Server (240).

2. Client Game Application:

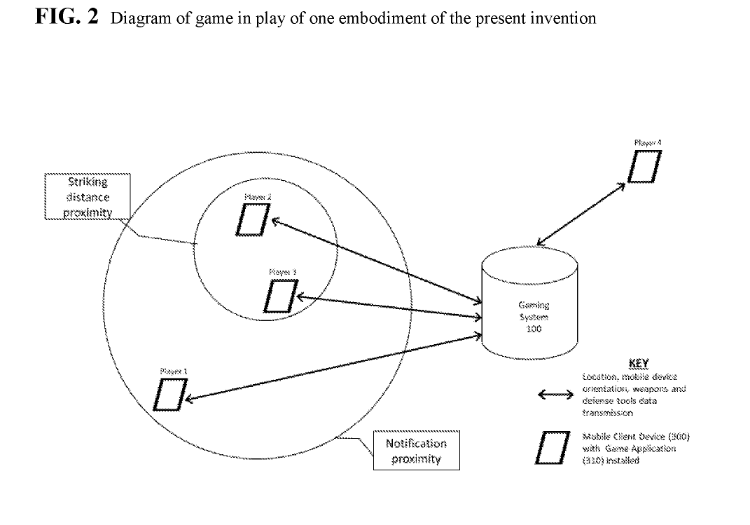

Referring to FIG. 2, showing the game in play in one embodiment of the present invention, the installed Game Application (310) will receive the geo-location coordinates and device orientation information from the Player's Mobile Client Device (300). The Game Application (310) will transmit those coordinates to the Gaming System (100). The Gaming System (100) will share these coordinates with the Game Application (310) of the Other Players when the Other Players are within a pre-defined outer radius (notification proximity). When players are within face-to-face proximity of Other Players (striking distance proximity), the Gaming System (100) will enable active interaction between the Players through the Gaming System's algorithms as seen on FIG. 1 (220)

In one embodiment of the Game Application, each player registered for a specific game will be randomly assigned a Target and will be randomly assigned to an Assassin by the Gaming System (100).

1. A server implemented method for enabling user members, using their mobile cell phone devices register to participate in a multiplayer game, consisting of a Host (“Host”) and Other Players (“Other Players”) and a set of rules associated therewith, which are stored on the server.

2. The invention of claim 1 further comprising of a mobile application (“the Application”) downloaded by the Host and Other Players onto their mobile cell phone devices.

3. The invention of claim 1 further comprising of the Host having the ability to define the parameters of a specific instance of the game, including start date and time, and creating a list of Other Players whom s/he wishes to invite to participate in that specific instance of the game through the Application.

4. The invention of claim 1, further comprising a computer server that generates invitations to the Other Players described in claim 3, which are generated both through the Application, and through email.

5. The invention of claim 1, further comprising of Other Players having the ability to decide whether to join or not join the game, through the Application.

6. The invention of claim 1, further comprising of algorithms which activate a game when the date and time of the specific instance of the game, designated by the Host (described in claim 2), occurs.

7. The invention of claim 1, further comprising of algorithms which randomly assign a target to each player who has agreed to play the game specified by the Host, such that each of the Host and Other Players are designated as both an Assassin and a Target. Assassins (“Assassins”) are defined as those players whose goal it is to eliminate Targets (“Targets”) from the game. Targets are defined as those players who will be eliminated from the game by the Assassins.

8. The invention of claim 1, further comprising algorithms on the server, which via email and through the Application, notify both the Host and the Other Players that the specific instance of the game has begun.

9. The invention of claim 1, further comprising of data and algorithms stored on the server which list virtual tools (“Tools”) available to the players, and define the abilities of the Tools, including, but not limited to, the range within which they can be used (“Predefined Range”), velocity, ability for reuse, quantity available, and type, i.e., attack, shield or defense.

10. The invention of claim 1, further comprising algorithms on server which calculate the proximity of the players to one another based on geo-location data sent from the Application to the server.

11. The invention of claim 1 responding to the notification described in claim 8, whereby the server sends a notification to the Application on each player's mobile phone device, notifying each player of the proximity of the Assassin and Target combination of players when they are within a predefined range of each other.

12. The invention of claim 1, further comprising algorithms stored on the server which determine whether the Assassin has killed its target based on: the geo-location of the mobile phone device; the orientation of the mobile device; the type of Tool chosen by the player; and an instruction to eliminate the Target, initiated by the Assassin in the Application; which information will be sent to the server from the mobile device.

13. The invention of claim 1, further comprising algorithms stored on the server which additionally collects information from the Target's Application to determine whether the Target has been successfully eliminated by the Assassin (as described in claim 12). This determination will be based on information sent to the server from the mobile device detailing the Target's ability to defend against an elimination instruction by an Assassin, using available Tools and the initiation in the Application of an instruction to defend.

14. The invention of claim 1, further comprising algorithms whereby if an Assassin successfully eliminates a Target (claims 12 and 13), the Assassin receives points in the game and any target(s) which was (were) assigned to the eliminated Target, become the new targets for the successful Assassin. The game continues until a single Assassin player remains.

15. The invention of claim 1, further comprising the rules associated with the game which are that:
a. There are two types of roles in each multiplayer game: Assassin and Target;
b. Each player is simultaneously a Target and an Assassin;
c. There is a minimum of three players in each multiplayer game;
d. There is no maximum number of players in each multiplayer game;
e. The players are within a specified radius of one another;
f. The radius identified by the server is either notification proximity, or striking distance proximity;
g. The size of the radii are determined by the assassin player's virtual weapon;
h. Tools are available to players and are acquired using credits, either awarded as a result of game play, or purchased by the users; and,
i. The Tools will each have unique capabilities for attack and defense.
